(19) United States
(12) Patent Application Publication
(10) Pub. No.: US 2026/0042641 A1
(43) Pub. Date: Feb. 12, 2026

(54) TRANSFORMER SPREADER BAR

(71) Applicant: Shawn BOLING, Salisbury, NC (US)

(72) Inventor: Shawn BOLING, Salisbury, NC (US)

(21) Appl. No.: 19/295,892

(22) Filed: Aug. 11, 2025

Related U.S. Application Data
(60) Provisional application No. 63/681,237, filed on Aug. 9, 2024.

(51) Int. Cl. B66C 1/12; H01F 27/00

(52) U.S. Cl. CPC B66C 1/12; H01F 27/002

(57) ABSTRACT

According to one or more embodiments a transformer spreader bar may be provided. The transformer spreader bar may include a base section having a first end and a plurality of pin holes and an extendible portion having a second end and plurality of pin holes. The extendible portion may extend out from the base section and be adjusted such that a length of the transformer spreader bar is adjusted. A pin may secure the base section and the extendible portion together through one or more of the plurality of pin holes.

### BACKGROUND

Transformers typically consist of a base portion and a lid portion which encloses and protects internal electronics and wiring. When repairing or otherwise performing work on transformers workers need to open the lid to perform work on the internals contained in the base portion, however the lid may often be unstable in its open position. Workers are then required to either constantly monitor the state of the lid over worries that it will close and disrupt work or block view to the internals or have additional workers standby to hold open the transformer reducing work efficiency and/or increasing danger.

### SUMMARY

According to one or more embodiments a transformer spreader bar may be provided. The transformer spreader bar may include a base section having a first end and a plurality of pin holes and an extendible portion having a second end and plurality of pin holes. The extendible portion may extend out from the base section and be adjusted such that a length of the transformer spreader bar is adjusted. A pin may secure the base section and the extendible portion together through one or more of the plurality of pin holes.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1A is a top view of an exemplary of a transformer spreader bar.

FIG. 1A is a front view of an exemplary transformer spreader bar.

FIG. 1C is another top view of an exemplary transformer spreader bar.

FIG. 1D is another view of an exemplary transformer spreader bar.

FIG. 2 is an exemplary transformer spreader bar and sling configuration.

FIG. 3 is an exemplary transformer and spreader bar setup.

FIG. 4 is an exemplary method for utilizing a spreader bar.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

In one or more exemplary embodiments a transformer spreader bar may be provided.

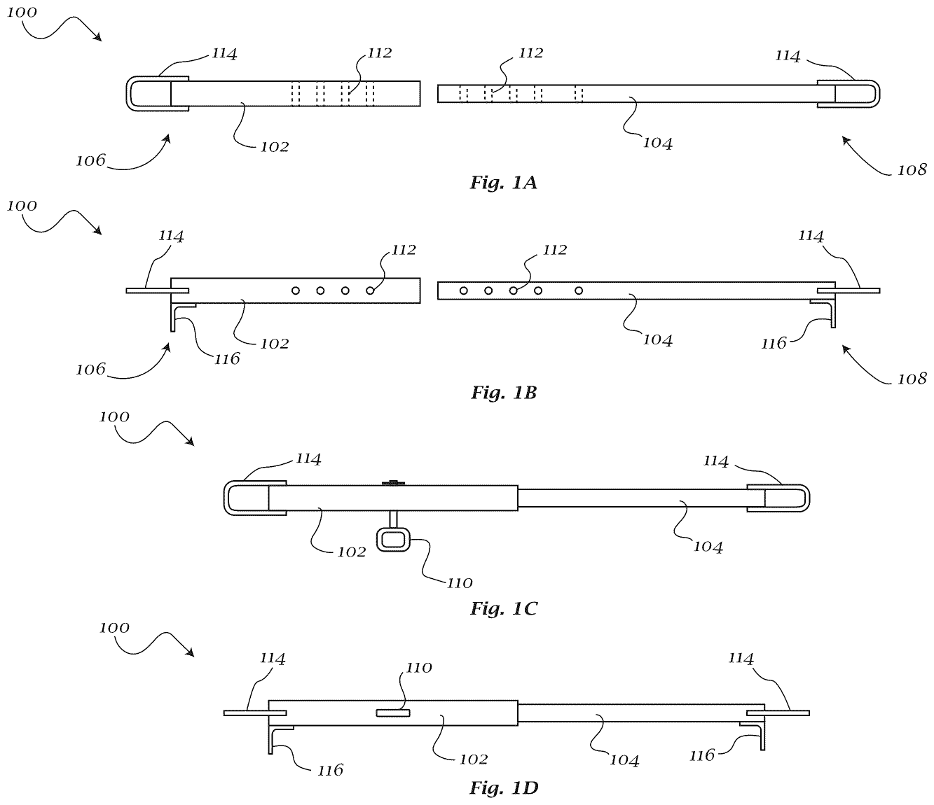

Referring to FIGS. 1A-1D, an exemplary transformer spreader bar 100 may be shown and described. The transformer spreader bar 100 may include a base section 102, an extendible portion 104, a first end 106, a second end 108, and a pin 110. The base section may be made of plastic, metal, wood, or any other material known in the art. The base section 102 may have a plurality of pin holes 112. The pin holes may be, for example, ½ inch holes along both the base section 102 and extendible portion 104 which may correspond to the size of the pin 110. In some embodiments the extendible portion 104 may have an additional hole over the base section 102, which may be used for, for example, storage of the pin 110, and/or to provide additional potential total lengths. The extendible portion 104 may fit within the base portion 102, and may change in length by sliding in or out of the base section 102. In an exemplary embodiment the base section 102 may be made of, for example, a 1¾× 3/16″ tubing, while the extendable portion 104 may be made of a smaller size tubing, for example a 1⅓× 3/16″ tubing, such that the extendable portion 104 fits within the base section 102. It may be understood that in other embodiments the extendable portion 104 may instead be larger than the base portion 104.

In an embodiment the pin 110 may be placed in one of the plurality of pin holes 112 in order to hold the extendible portion 104 at a particular length. For example, the total length of the spreader bar 100 may be 32″, 33½″, etc up to a length of 45½″. In some embodiments the interior lengths may be regular, e.g. every 1″, 1½″, 2″, etc, or may be specific lengths determined by, for example, potential use case lengths such as in order to fit a specified range of transformer boxes. In an embodiment the pin 110 may be loosened so the length of the extendible portion 104 may be adjusted, and the pin 110 may be tightened to secure the extendible portion 104 at the adjusted to length. In some embodiments the pin 110 may include a backstop or cap which may be used to securely hold the pin 110 in place. Loosening may be, for example, through a screwing action and or by removing the pin entirely.

The first end 106 may be attached to the end of the base section 102, and the second end 108 may be attached to the end of the extendible portion 104. The first end 106 and the second end 108 may be made of, for example, plastic, metal, etc and/or may simply be the end portion of the base section 102 or extendible portion 104. In some embodiments the first end 106 and the second end 108 may be covered in, for example, a dip coating, which may prevent scratching when installed on a transformer. The first end 106 and the second end 108 may include a loop portion 114 and a corner portion 116. It may be understood that the loop portion 114 may be large enough for, for example, a tag line, rope, or sling, to be fed through the loop portion 114. In an embodiment the corner portion 116 may extend perpendicular to the direction of the base section 102 and the extendible portion 104. The corner portion 116 may be, for example, stainless steel attached at an L2×2× 3/16 Angle. Loop portion 114 and the corner portion 116 may further be covered in a coating such as a dip coating.

In other embodiments it may be understood that the extendible portion may be secured to the base portion through a method other than a pin and pin hole system, for example a spring system, a screw system, or any other system known in the art.

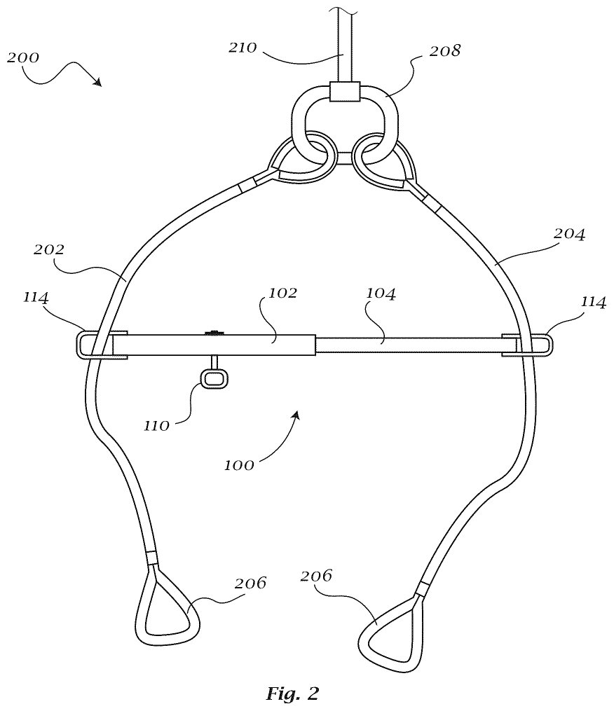

Referring to FIG. 2 an exemplary spreader bar and sling configuration 200 may be shown and described. In some embodiments a sling setup may include a first sling 202 and a second sling 204, which may be threaded through the loop portion 114 of the first end 106 and the second end 108 of the spreader bar 100 respectively. The first sling 202 and the second sling 204 may be, for example, a rope with an elastic section. The first sling 202 and the second sling 204 may further have a sling handle or loop 206. In some embodiments the first sling 202 and the second sling 204 may further be connected by a connector 208, which may be, for example, a metal ring or a carabiner. In some embodiments the connector 208 may further be connected to another line 210 which may be, for example, a swivel hook.

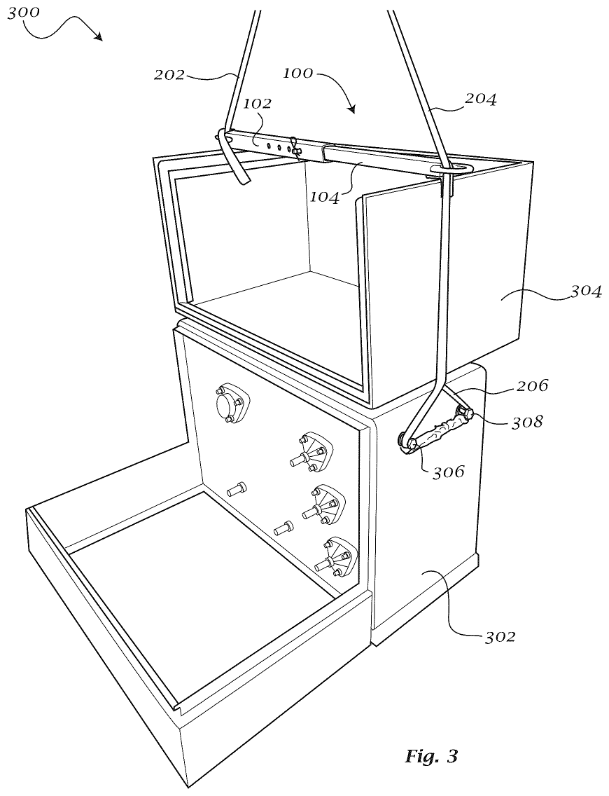

Referring to FIG. 3 an exemplary transformer and spreader bar setup 300 may be shown and described. In an embodiment a transformer may have a transformer base 302 and a transformer lid 304. The spreader bar and sling configuration 200 may attach the transformer via a first transformer pin 306 and a second transformer pin 308, by attaching the sling loops 206 around the first transformer pin 306 and the second transformer pin 308.

In an embodiment the spreader bar 100 may be placed over the transformer lid 304 and the length may be adjusted via the extendible portion 104 to fit a plurality of different transformer lid sizes. In an embodiment the corner portion may be placed so they are outside the transformer lid 304 and the spreader bar 100 may be tightened so the spreader bar 100 is secure on the transformer lid 304. It may be understood that once the spreader bar 100 is installed on the transformer lid 304 the transformer lid 304 may be securely held in an open position providing a full view during work on the transformer.

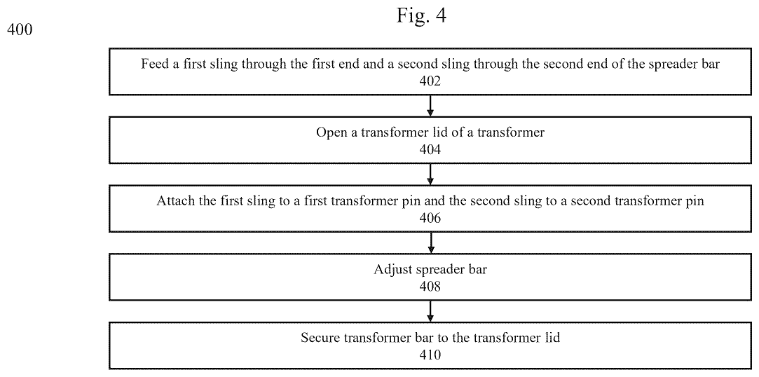

Referring to FIG. 4 an exemplary method for utilizing a spreader bar may be shown and described. In a first step 402 a first sling may be fed through a first end of the spreader bar, and a second sling may be fed through a second end of the spreader bar. In a second step 404 a transformer box may be opened as required for performing maintenance work on the transformer box, for example by raising a lid of the transformer box. In a third step 406 the first sling may be attached to a first transformer pin located on the exterior of the transformer box and the second sling may be attached to a second transformer pin located on a different side of the exterior of the transformer box the attachment of the slings may be understood to help stabilize the spreader bar location relative to the lid of the transformer box. In a fourth step 408 the spreader bar may be adjusted via, for example, the pin system so as to match a size of an opening of the transformer box left by, for example, the lid being raised and/or to match the size of the lid. In a final step 410 the spreader bar may be placed across the transformer box lid thereby securing the lid and preventing the lid from closing. It may be understood that the steps above are not limited to the order described, and in other embodiments the order may be different, for example step 408 may be performed before step 406 and/or all steps may not need to be performed.

It may be understood that the above description describes the spreader bar with respect to a transformer box embodiment, however in other embodiments the spreader bar may be used in conjunction with any other form of industrial equipment which requires a lid be opened and held open for work to be performed. It may further be understood that when utilized on a transformer the bar may keep a lid in an open position for the duration of removing and installing a transformer, and may further allow for full exposure of the internals while keeping the lid secure.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A transformer spreader bar comprising:
a base section having a first end and a plurality of pin holes;
an extendible portion having a second end and plurality of pin holes, the extendible portion configured to extend out from the base section and be adjusted such that a length of the transformer spreader bar is adjusted;
a pin configured to secure the base section and the extendible portion together through one or more of the plurality of pin holes.

2. The transformer spreader bar of claim 1, wherein the first end and the second end each comprise at least a loop portion and a corner portion, the loop portion configured to accept a tag line, rope, or sling.

3. The transformer spreader bar of claim 2, wherein the corner portion of the first end extends perpendicular from the base section and the corner portion of the second end extends perpendicular from the extendible portion.

4. The transformer spreader bar of claim 3, wherein the first end and the second end are each covered in at least a dip coating.

5. The transformer spreader bar of claim 1, wherein the transformer spreader bar is configured so that the length adjusts from a minimum length of 32 inches to a maximum length of 45½ inches.

6. The transformer spreader bar of claim 1, wherein a diameter of the extendible portion is smaller than a diameter of the base section such that the extendible portion fits within the base section.

7. A method of utilizing a transformer spread bar comprising:
opening a lid of a transformer box;
adjusting a length of the transformer spreader bar to match a size of the lid; and
securing the transformer spreader bar to the lid of the transformer box such that the lid is prevented from closing;
wherein the transformer spread bar comprises:
a base section having a first end and a plurality of pin holes;
an extendible portion having a second end and plurality of pin holes, the extendible portion configured to extend out from the base section and be adjusted such that a length of the transformer spreader bar is adjusted;
a pin configured to secure the base section and the extendible portion together through one or more of the plurality of pin holes.

8. The method of claim 7, wherein the first end and the second end each comprise at least a loop portion and a corner portion, the loop portion configured to accept a tag line, rope, or sling.

9. The method of claim 8, further comprising feeding a first rope or sling through the first end and feeding a second rope or sling through the second end;
attaching the first rope or sling to a first transformer pin located on an exterior of the transformer box;
attaching the second rope or sling to a second transformer pin located on a different portion of the exterior of the transformer box.

10. The method of claim 9, wherein the corner portion of the first end extends perpendicular from the base section and the corner portion of the second end extends perpendicular from the extendible portion.
